(19) United States
(12) Patent Application Publication
(10) Pub. No.: US 2017/0261989 A1
(43) Pub. Date: Sep. 14, 2017

(54) VEHICLE CONTROL SYSTEM, VEHICLE CONTROL METHOD, AND VEHICLE CONTROL PROGRAM

(71) Applicant: HONDA MOTOR CO., LTD., Tokyo (JP)

(72) Inventors: Atsushi Ishioka, Wako-shi (JP); Toru Kokaki, Wako-shi (JP)

(73) Assignee: HONDA MOTOR CO., LTD., Tokyo (JP)

(21) Appl. No.: 15/458,306

(22) Filed: Mar. 14, 2017

(30) Foreign Application Priority Data
Mar. 14, 2016 (JP) 2016-050165

(51) Int. Cl. G05D 1/02; G01C 21/34

(52) U.S. Cl. CPC G05D 1/0212; G01C 21/34; G05D 2201/0213; G05D 1/0278; G01S 19/39

(57) ABSTRACT

A vehicle control system that includes: a course generation section that, when input with a position and state of a vehicle and a position and state of the vehicle, uses a function determining a course from the start point to the end point to generate an expected course that a vehicle will travel, that infers the position and state of the end point based on a current position and state of the vehicle, and that generates the course by inputting the inferred position and state of the end point into the function; and a travelling controller that automatically controls at least steering of the vehicle such that the vehicle travels along the course generated by the course generation section.

### CROSS REFERENCES TO RELATED APPLICATIONS

The present application claims priority under 35 U.S.C. §119 to Japanese Patent Application No. 2016-050165, filed Mar. 14, 2016, entitled “Vehicle Control System, Vehicle Control Method, and Vehicle Control Program.” The contents of this application are incorporated herein by reference in their entirety.

### BACKGROUND

1. Field

The present disclosure relates to a vehicle control system, a vehicle control method, and a vehicle control program.

Technology is known for setting vehicle passage points and generating a course that passes through the passage points using a spline function (for example, see Japanese Unexamined Patent Application No. 8-123547). In this course generation technology, a start point, an end point, and passage intersection points are designated in map information, main passage points are produced passing through the designated start point, end point, and passage intersection points, and a course is generated following a spline curve passing through the main passage points.

2. Description of the Related Art

However, since the spline curve depends on information other than the start point and the end point, the end point sometimes cannot be set at an appropriate position, and processing load sometimes increases due to correcting and evaluating the course.

### SUMMARY

The present disclosure describes a vehicle control system, a vehicle control method, and a vehicle control program capable of generating an appropriate course by simple processing.

A first aspect of the present disclosure describes a vehicle control system including: a course generation section that, when input with a position and state of a start point and a position and state of an end point, uses a function determining a course from the start point to the end point to generate an expected course that a vehicle will travel, that infers the position and state of the end point based on a current position and state of the vehicle, and that generates the course by inputting the inferred position and state of the end point into the function; and a travelling controller that automatically controls at least steering of the vehicle such that the vehicle travels along the course generated by the course generation section.

A second aspect of the present disclosure describes the vehicle control system of the first aspect, wherein configuration may be made such that the function also requires input of a needed time taken for the vehicle to move from the start point to the end point, and the course generation section infers the needed time based on an amount of movement in a lateral direction by the vehicle, and generates the course by inputting the inferred needed time into the function.

A third aspect of the present disclosure describes the vehicle control system of the second aspect, wherein configuration may be made such that the course generation section infers the position of the end point as a position further from the vehicle, the longer the length of the needed time.

A fourth aspect of the present disclosure describes the vehicle control system of the first aspect, wherein configuration may be made such that the function is a spline function.

A fifth aspect of the present disclosure describes a vehicle control method performed by an onboard computer, the method including: processing that, when input with a position and state of a start point and a position and state of an end point, uses a function determining a course from the start point to the end point to generate an expected course that a vehicle will travel, that infers the position and state of the end point based on a current position and state of the vehicle, and that generates the course by inputting the inferred position and state of the end point into the function; and processing that automatically controls at least steering of the vehicle such that the vehicle travels along the generated course.

A sixth aspect of the present disclosure describes a vehicle control program that causes an onboard computer to execute: processing that, when input with a position and state of a start point and a position and state of an end point, uses a function determining a course from the start point to the end point to generate an expected course that a vehicle will travel, that infers the position and state of the end point based on a current position and state of the vehicle, and that generates the course by inputting the inferred position and state of the end point into the function; and processing that automatically controls at least steering of the vehicle such that the vehicle travels along the generated course.

According to the disclosure of the first aspect to the sixth aspect, a vehicle control system can generate a suitable course by simple processing, by inferring the position and state of an end point based on the current position and state of the vehicle.

### BRIEF DESCRIPTION OF THE DRAWINGS

FIG. 1 is a diagram illustrating configuration elements of a vehicle installed with a vehicle control system of respective embodiments.

FIG. 2 is a functional configuration diagram of a vehicle installed with a vehicle control system according to an embodiment.

FIG. 3 is a diagram illustrating a state in which the position of a vehicle relative to a travel lane is recognized by a vehicle position recognition section.

FIG. 4 is a diagram illustrating an example of an action plan generated for a given segment.

FIG. 5 is a diagram illustrating an example of a configuration of a course generation section.

FIG. 6A to FIG. 6D are diagrams illustrating an example of a candidate for a course generated by a course candidate generation section.

FIG. 7 is a diagram for explaining processing to calculate a course executed by a course candidate generation section of an embodiment.

FIG. 8 is a flowchart illustrating a flow of processing that generates candidates for a course executed by a course candidate generation section.

FIG. 9 is a diagram for explaining acquisition of a needed time.

FIG. 10 is a diagram illustrating an end point when the lane width is wider than in the example of FIG. 9.

FIG. 11 is a flowchart illustrating another example of a flow of processing executed when a lane-change event is carried out.

FIG. 12 is a diagram illustrating a state in which a target position is set.

FIG. 13 is a diagram illustrating a state in which a course for lane changing is generated.

FIG. 14 is a diagram illustrating an example in which a predicted displacement from an end point is applied.

FIG. 15 is a functional configuration diagram of the vehicle centered on a vehicle control system according to a second embodiment.

### DESCRIPTION OF THE PREFERRED EMBODIMENTS

Explanation follows regarding an embodiment of a vehicle control system, a vehicle control method, and a vehicle control program of the present disclosure, with reference to the drawings.

### Common Configuration

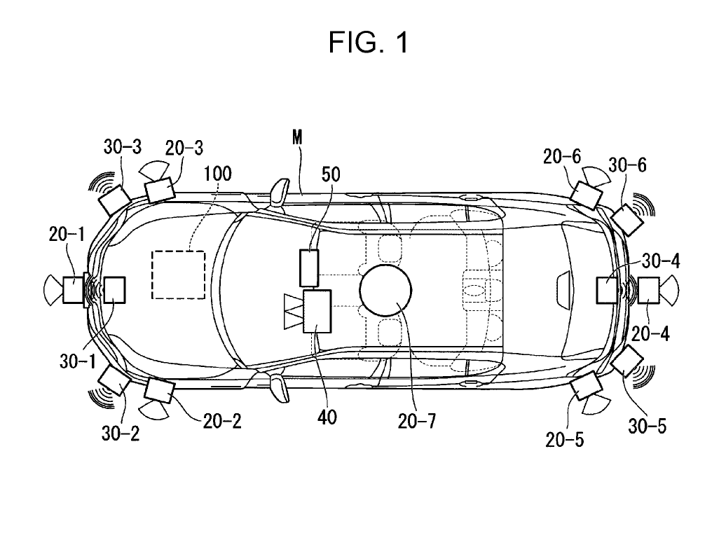

FIG. 1 is a diagram illustrating configuration elements of a vehicle (referred to as the vehicle M hereafter) installed with a vehicle control system 100 of each embodiment. The vehicle installed with the vehicle control system 100 is, for example, a two-wheeled, three-wheeled, or four-wheeled automobile, and this encompasses automobiles having an internal combustion engine such as a diesel engine or gasoline engine as a power source, automobiles having an electrical motor as a power source, and hybrid automobiles having both an internal combustion engine and an electrical motor. Electric automobiles are, for example, driven using electric power discharged from a battery such as a secondary battery, a hydrogen fuel cell, a metal fuel cell, or an alcohol fuel cell.

As illustrated in FIG. 1, sensors such as finders 20-1 to 20-7, radars 30-1 to 30-6, and a camera 40, a navigation device 50, and a vehicle control system 100 are installed to the vehicle M.

The finders 20-1 to 20-7 are, for example, light detection and ranging, or laser imaging detection and ranging (LIDAR) sensors that measure scattering of illuminated light to measure the distance to a target. For example, the finder 20-1 is attached to a front grill or the like, and the finder 20-2 and the finder 20-3 are attached to a vehicle body side face, a door mirror, a front headlamp interior, a side lamp vicinity, or the like. The finder 20-4 is attached to a trunk lid or the like, the finder 20-5 and the finder 20-6 are attached to a vehicle body side face, a tail light interior, or the like. The finders 20-1 to 20-6 described above have detection regions of, for example, approximately 150° relative to a horizontal direction. The finder 20-7 is attached to a roof or the like. The finder 20-7 has a detection region of, for example, 360° relative to the horizontal direction.

The radar 30-1 and the radar 30-4 are, for example, long-range millimeter wave radars having a wider detection region in the depth direction than the other radars. The radars 30-2, 30-3, 30-5, 30-6 are intermediate-range millimeter wave radars having a narrower detection region in the depth direction than the radars 30-1 and 30-4.

Hereafter, the finders 20-1 to 20-7 are simply referred as “finders 20” in cases in which no particular distinction is made, and the radars 30-1 to 30-6 are simply referred to as “radars 30” in cases in which no particular distinction is made. The radars 30, for example, detect objects using a frequency modulated continuous wave (FM-CW) method.

The camera 40 is, for example, a digital camera that employs a solid state imaging element such as a charge coupled device (CCD) or complementary metal oxide semiconductor (CMOS). The camera 40 is attached to a front windshield upper portion, a back face of a rear-view mirror, or the like. The camera 40, for example, periodically and repeatedly images ahead of the vehicle M. The camera 40 may be a stereo camera that includes plural cameras.

Note that the configuration illustrated in FIG. 1 is merely an example; a portion of the configuration may be omitted, and other configuration may be further added.

### First Embodiment

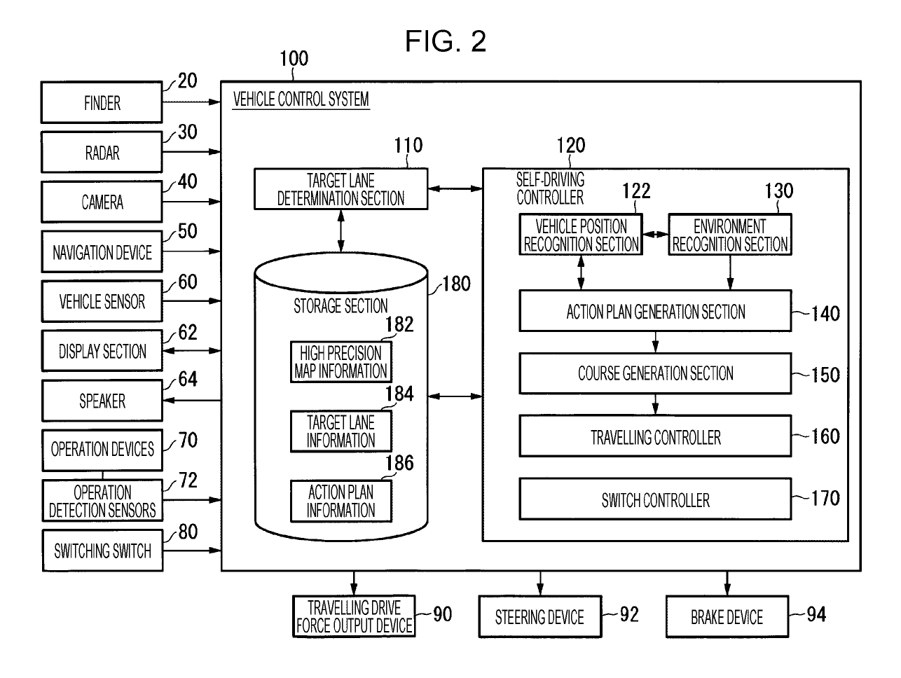

FIG. 2 is a functional configuration diagram of the vehicle M installed with the vehicle control system 100 according to a first embodiment. In addition to the finders 20, the radars 30, and the camera 40, the vehicle M is installed with the navigation device 50, a vehicle sensor 60, operation devices (operation elements) 70 such as an accelerator pedal, a brake pedal, a shift lever (or a paddle shift), and a steering wheel, operation detection sensors 72 such as an accelerator opening sensor, a brake press-amount sensor (brake switch), a shift position sensor, and a steering angle sensor (or a steering torque sensor), a switching switch 80, a travelling drive force output device 90, a steering device 92, a brake device 94, and a vehicle control system 100. These devices and mechanisms are connected to one another by a multi-channel communication line such as a controller area network (CAN) communication line, a serial communication line, a wireless communication network, or the like. The given operation devices are merely examples, and the vehicle M may also be installed with a joystick, a button, a dial switch, a graphic user interface (GUI) switch, or the like. Note that the vehicle control system 100 is not the only vehicle control system in the scope the claims; out of the configuration illustrated in FIG. 2, configuration other than that of the vehicle control system 100 (such as the finders 20) may be included.

The navigation device 50 includes a global navigation satellite system (GNSS) receiver, map information (a navigation map), a touch panel display device that functions as a user interface, a speaker, a microphone, and the like. The navigation device 50 identifies the position of the vehicle M using the GNSS receiver and derives a route from that position to a destination designated by the user. The route derived by the navigation device 50 is provided to a target lane determination section 110 of the vehicle control system 100. The position of the vehicle M may be identified or complemented by an inertial navigation system (INS) employing output from the vehicle sensor 60. When the vehicle control system 100 is executing a manual driving mode, the navigation device 50 provides guidance along a route to the destination using audio and a navigation display. Note that configuration for identifying the position of the vehicle M may be provided independently from the navigation device 50. Moreover, the navigation device 50 may, for example, be implemented by functionality of a terminal device such as a smartphone or a tablet terminal possessed by the user. In such cases, information is exchanged between the terminal device and the vehicle control system 100 using wireless or wired communication.

The vehicle sensor 60 includes a vehicle speed sensor that detects the vehicle speed, an acceleration sensor that detects acceleration, a yaw rate sensor that detects angular speed of rotation about a vertical axis, a heading sensor that detects the heading of the vehicle M, and the like.

A display section 62 displays information as an image. The display section 62 includes, for example, a liquid crystal display (LCD), an organic electroluminescence (EL) display device, a head up display, or the like. The display section 62 may be a display section provided to the navigation device 50, or may be a display section of an instrument panel that displays the state of the vehicle M (such as the speed). A speaker 64 outputs information as audio.

The operation detection sensors 72 outputs the accelerator opening, the brake press-amount, the shift position, the steering wheel steering angle, the steering torque, or the like to the vehicle control system 100 as a detection result. Note that alternatively, depending on the driving mode, the detection result of the operation detection sensors 72 may be directly output to the travelling drive force output device 90, the steering device 92, or the brake device 94.

The switching switch 80 is a switch operated by a vehicle occupant. The switching switch 80 receives operation by the vehicle occupant, generates a driving mode designation signal that designates a driving mode of the vehicle M, and outputs the generated driving mode designation signal to a switch controller 170. The switching switch 80 may be a graphical user interface (GUI) switch, or a mechanical switch.

The travel drive output device 90 outputs travelling drive force (torque) to drive wheels to cause the vehicle to travel. In cases in which the vehicle M is an automobile that has an internal combustion engine as the power source, the travel drive output device 90 includes, for example, an engine, a transmission, and an engine electronic control unit (ECU) that controls the engine. In cases in which the vehicle M is an electric automobile that has an electrical motor as the power source, the travel drive output device 90 includes, for example, a travel motor and a motor ECU that controls the travel motor. In cases in which the vehicle M is a hybrid automobile, the travel drive output device 90 includes, for example, an engine, a transmission, and an engine ECU, and a travel motor and travelling motor ECU. In cases in which the travel drive output device 90 includes only an engine, the engine ECU adjusts the engine throttle opening, the shift level, or the like, in accordance with information input from a travelling controller 160, described later. In cases in which the travel drive output device 90 includes only a travel motor, the motor ECU adjusts a duty ratio of a PWM signal applied to the travel motor, in accordance with information input from the travelling controller 160. In cases in which the travel drive output device 90 includes an engine and a travel motor, the engine ECU and the motor ECU cooperatively control travelling drive force, in accordance with information input from the travelling controller 160.

The steering device 92 includes, for example, a steering ECU and an electric motor. The electric motor, for example, places force on a rack and pinion mechanism to change the orientation of the steering wheel. The steering ECU drives the electric motor in accordance with information input from the vehicle control system 100, or input information regarding the steering angle or steering torque, and changes the orientation of the steering wheel.

The brake device 94 is, for example, an electric servo brake device including a brake caliper, a cylinder that transmits hydraulic pressure to the brake caliper, an electric motor that causes the cylinder to generate hydraulic pressure, and a brake controller. The brake controller of the electric servo brake device controls an electric motor in accordance with information input from the travelling controller 160, such that braking torque is output to each wheel in accordance with the braking operation. The electric servo brake device may include a mechanism that transmits hydraulic pressure generated due to operation of the brake pedal to the cylinder via a master cylinder as a backup. Note that the brake device 94 is not limited to the electric servo brake device explained above, and may be an electrically controlled hydraulic pressure brake device. The electrically controlled hydraulic pressure brake device controls an actuator in accordance with information input from the travelling controller 160, and transmits hydraulic pressure of a master cylinder to the cylinder. The brake device 94 may also include a regenerative brake for the travel motor that can be included in the travel drive output device 90.

### Vehicle Control System

Explanation follows regarding the vehicle control system 100. The vehicle control system 100 is, for example, implemented by one or more processors, or by hardware having equivalent functionality. The vehicle control system 100 may be configured by a combination of a processor such as a central processing unit (CPU), a storage device, and an electronic control unit (ECU) in which a communication interface is connected by an internal bus, or an micro-processing unit (MPU) or the like.

The vehicle control system 100 includes, for example, the target lane determination section 110, a self-driving controller 120, and a storage section 180. The self-driving controller 120 includes, for example, a vehicle position recognition section 122, an environment recognition section 130, an action plan generation section 140, a course generation section 150, a travelling controller 160, and a switch controller 170. Some or all out of the respective sections of the target lane determination section 110 and the self-driving controller 120 may be implemented by a processor executing a program (software). Moreover, of these, some or all may be implemented by hardware such as a large scale integration (LSI) or an application specific integrated circuit (ASIC), or may be implemented by a combination of software and hardware.

The storage section 180 stores information such as high precision map information 182, target lane information 184, and action plan information 186. The storage section 180 is implemented by read only memory (ROM), random access memory (RAM), a hard disk drive (HDD), flash memory, or the like. The program executed by the processor may be pre-stored in the storage section 180, or may be downloaded from an external device via onboard internet equipment or the like. Moreover, the program may be installed in the storage section 180 by loading a portable storage medium storing the program into a drive device, not illustrated in the drawings. Moreover, the vehicle control system 100 may be distributed across plural computer devices.

The target lane determination section 110 is, for example, implemented by an MPU. The target lane determination section 110 divides the route provided from the navigation device 50 into plural blocks (for example, divides the route every 100 m along the vehicle advance direction), and references the high precision map information 182 to determine the target lane for each block. The target lane determination section 110, for example, determines which lane number from the left to travel on. In cases in which a branch point, a merge point, or the like is present in the route, the target lane determination section 110, for example, determines a target lane so as to enable the vehicle M to travel along a sensible travel route for advancing beyond the branch. The target lane determined by the target lane determination section 110 is stored in the storage section 180 as the target lane information 184.

The high precision map information 182 is map information with higher precision than the navigation map of the navigation device 50. The high precision map information 182 includes, for example, lane-center information, lane-boundary information, or the like. Moreover, the high precision map information 182 may include, for example, road information, traffic restriction information, address information (address, zip code) facilities information, phone number information, and the like. The road information includes information such as information indicating whether the type of road is an expressway, a toll road, a national highway, or a prefectural road, the number of lanes in the road, the width of each lane, the gradient of the road, the curvature of the lanes, the position of lane merge and branch points, and signage provided on the road. The traffic restriction information includes information regarding lane closures due to road work, traffic accidents, congestion, and the like.

The vehicle position recognition section 122 of the self-driving controller 120 recognizes the lane in which the vehicle M is travelling (the travel lane) and the position of the vehicle M relative to the travel lane, based on the high precision map information 182 stored in the storage section 180, and the information input from the finders 20, the radars 30, the camera 40, the navigation device 50, or the vehicle sensor 60.

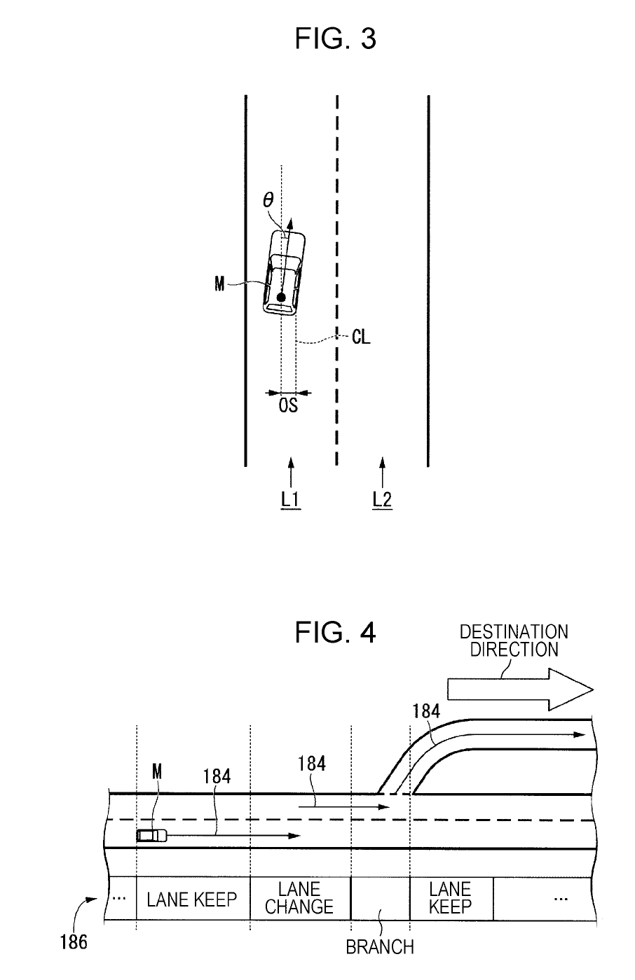

FIG. 3 is a diagram illustrating a state in which the position of the vehicle M relative to a travel lane L1 is recognized by the vehicle position recognition section 122. The vehicle position recognition section 122, for example, recognizes an offset OS between a reference point (for example, the center of mass) of the vehicle M and a travel lane center CL, and recognizes an angle θ formed between the advance direction of the vehicle M and a line aligned with the travel lane center CL as the position of the vehicle M relative to the travel lane L1. Note that, alternatively, the vehicle position recognition section 122 may recognize the position of the reference point of the vehicle M or the like with respect to either of the side end portions of the vehicle lane L1 as the position of the vehicle M relative to the travel lane. The relative position of the vehicle M recognized by the vehicle position recognition section 122 is provided to the target lane determination section 110.

The environment recognition section 130 recognizes the position, speed, and acceleration states, and the like of surrounding vehicles based on the information input from the finders 20, the radars 30, the camera 40, and the like. Surrounding vehicles are, for example, vehicles that are travelling in the surroundings of the vehicle M and that are travelling in the same direction as the vehicle M. The positions of the surrounding vehicles may be indicated as representative points such as centers of mass or corners of other vehicles, or may be represented as regions represented by the outlines of other vehicles. The “state” of a surrounding vehicle may include whether or not the surrounding vehicle is accelerating or changing lanes (or whether or not the surrounding vehicle is attempting to change lanes), as ascertained based on the information of the various devices described above. Moreover, the environment recognition section 130 may recognize the position of a guard rail, a utility pole, a parked vehicle, a pedestrian, and other objects, in addition to the surrounding vehicles.

The action plan generation section 140 sets a starting point of self-driving and/or a destination of self-driving. The starting point of self-driving may be the current position of the vehicle M, or may be a point set by an operation to instruct self-driving. The action plan generation section 140 generates an action plan in the segments between the starting point and the destination of self-driving. Note that there is no limitation thereto, and the action plan generation section 140 may generate an action plan for freely selected segments.

The action plan is, for example, composed of plural events to be sequentially executed. The events include, for example, a deceleration event that decelerates the vehicle M, an acceleration event that accelerates the vehicle M, a lane-keep event that causes the vehicle M to travel without departing from the travel lane, a lane-change event that causes the travel lane to change, an overtake event that causes the vehicle M to overtake the vehicle in front, a branch event that causes a lane change to the desired lane at a branch point or causes the vehicle M to travel so as not to depart from the current travel lane, a merge event that causes the vehicle M to accelerate or decelerate in a merging lane for merging with a main lane and changes the travel lane. The action plan generation section 140 sets a lane-change event, a branch event, or a merge event at places where the target lane determined by the target lane determination section 110 switches. Information indicating the action plan generated by the action plan generation section 140 is stored in the storage section 180 as the action plan information 186.

FIG. 4 is a diagram illustrating an example of the action plan generated for a given segment. As illustrated in FIG. 4, the action plan generation section 140 generates the action plan needed for the vehicle M to travel in the target lane indicated by the target lane information 184. Note that the action plan generation section 140 may dynamically change the action plan irrespective of the target lane information 184, in accordance with changes to the conditions of the vehicle M. For example, in cases in which the speed of a surrounding vehicle recognized by the environment recognition section 130 during vehicle travel exceeds a threshold value, or the movement direction of a surrounding vehicle travelling in a lane adjacent to the vehicle lane is toward the vehicle lane direction, the action plan generation section 140 changes the event set in driving segments that the vehicle M is expected to travel. For example, in cases in which an event is set such that a lane-change event is to be executed after a lane-keep event, when it has been determined by the recognition result of the environment recognition section 130 that a vehicle is advancing at a speed of the threshold value or greater from the rear of the lane change target lane during the lane-keep event, the action plan generation section 140 may change the event following the lane-keep event from a lane-change event to a deceleration event, a lane-keep event, or the like. As a result, the vehicle control system 100 can cause the vehicle M to self-travel safely even in cases in which a change occurs to the state of the environment.

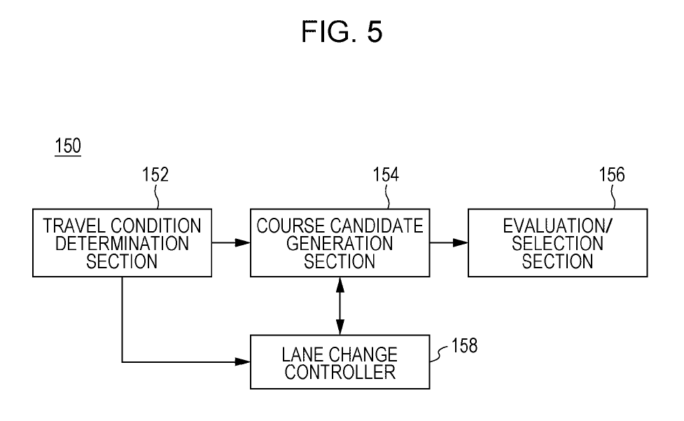

FIG. 5 is a diagram illustrating an example of the configuration of the course generation section 150. The course generation section 150 includes, for example, a travel condition determination section 152, a course candidate generation section 154, an evaluation/selection section 156, and a lane change controller 158.

When implementing a lane-keep event, the travel condition determination section 152, for example, determines a travel condition from out of fixed speed travel, following-travel, deceleration travel, curve travel, obstacle avoidance travel, or the like. For example, the travel condition determination section 152 determines that the travel condition is fixed speed travel when no other vehicles are present ahead of the vehicle M. The travel condition determination section 152 determines that the travel condition is following-travel in cases such as travel following a vehicle in front. The travel condition determination section 152 determines that the travel condition is deceleration travel in cases in which deceleration of the vehicle in front is recognized by the environment recognition section 130, and in cases in which an event for, for example, stopping or parking is carried out. The travel condition determination section 152 determines that the travel condition is curve travel in cases in which the environment recognition section 130 recognizes that the vehicle M has come to a curve. The travel condition determination section 152 determines that the travel condition is obstacle avoidance travel in cases in which the environment recognition section 130 has recognized an obstacle in front of the vehicle M.

The course candidate generation section 154 generates candidates for the course based on the travel conditions determined by the travel condition determination section 152. The course of the present embodiment is a collection of a target position (course points) for each specific time in the future (or each specific travel distance) where the reference position (for example, the center of mass or rear wheel axle center) of the vehicle M is to arrive. The course candidate generation section 154 computes a target speed of the vehicle M based on at least the speed of an target object OB present in front of the vehicle M recognized by the environment recognition section 130 and the distance between the vehicle M and the target object OB. The course candidate generation section 154 generates one or more courses based on the computed target speed. Target object OB encompasses objects and like such as the vehicle in front, points such as merge points, branch points, and destination points, and obstacles.

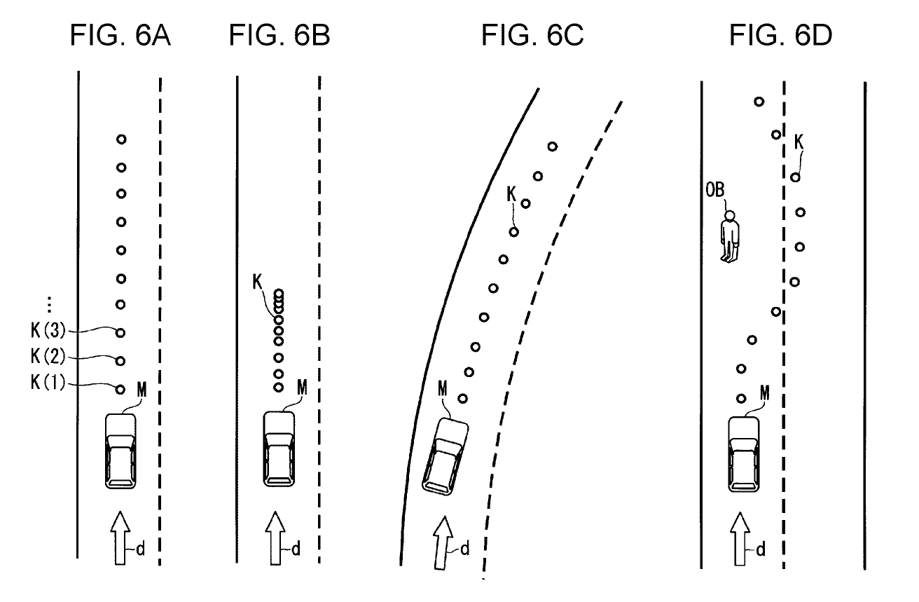

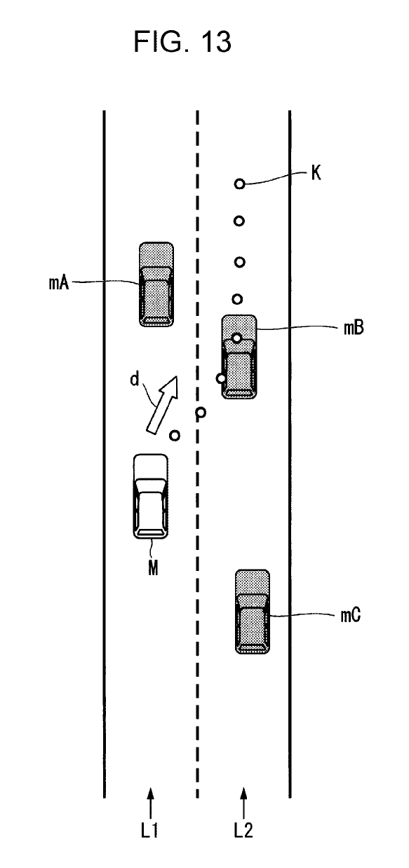

FIG. 6A to FIG. 6D are diagrams illustrating examples of candidates for the course generated by the course candidate generation section 154. Note that in the FIG. 6A to 6D and in FIG. 13, described later, explanation follows regarding one typical course from out of plural settable candidates for the course, or just one course selected by the evaluation/selection section 156. As illustrated in FIG. 6A for example, the course candidate generation section 154 sets course points K(1), K(2), K(3), . . . for each elapse of a specific amount of time Δt from the current time, with reference to the current position of the vehicle M. Reference is sometimes made to simply “course point K” below when no distinction is made between the course points.

When the travel condition determined by the travel condition determination section 152 is fixed speed travel, the course candidate generation section 154 sets plural, evenly separated course points K as illustrated in FIG. 6A. When such simple courses are generated, the course candidate generation section 154 may generate a single course alone.

When the travel condition determined by the travel condition determination section 152 is decelerating travel (including following-travel when the vehicle in front has decelerated), the course candidate generation section 154 generates a course by making separations between the course points K wider the sooner the timing of arrival, and by making the separations between the course points K narrower the later the timing of arrival, as illustrated in FIG. 6B. In this case, the vehicle in front is sometimes set as the target object OB, and points other than the vehicle in front such as merge points, branch points, and destination points, obstacles, and the like are sometimes set as the target object OB. The travelling controller 160, described later, accordingly causes the vehicle M to decelerate since the course points K having a later timing of arrival from the vehicle M approach the current position of the vehicle M.

When the travelling condition determined by the travel condition determination section 152 is curve travel, the course candidate generation section 154 places the plural course points K while changing the lateral position (position in the lane width direction) for the advance direction of the vehicle M, as illustrated in FIG. 6C, in accordance with the curve of the road. When an obstacle OB such as a person or stopped vehicle is present on the road in front of the vehicle M, the course candidate generation section 154 places the plural course points K so as to travel while avoiding the obstacle OB, as illustrated in FIG. 6D.

The evaluation/selection section 156 for example evaluates the candidates for the course generated by the course candidate generation section 154 from the two viewpoints of plan quality and safety, and selects a course to output to the travelling controller 160. From the viewpoint of plan quality, courses are evaluated highly in cases in which, for example, an already generated plan (for example, an action plan) is followed well and the total length of the course is short. For example, in cases in which a lane change in the rightward direction is desired, courses that temporarily change lanes in the leftward direction and then return have a low evaluation. From the viewpoint of safety, for example, the further the distance between the vehicle M and objects (such as surrounding vehicles) and the smaller the amount of change in acceleration/deceleration, steering angle, or the like, the higher the evaluation.

### Lane Changing

The lane change controller 158 operates when implementing an operation such as a lane-change event, a branch event, or a merge event, namely when performing lane changes in a broad sense.

Explanation follows regarding an example of processing executed by the course generation section 150 during a lane change by the vehicle M in cases in which no surrounding vehicles that would interfere with the lane change are present in the surroundings of the vehicle M. No surrounding vehicles that would interfere with the lane change by the vehicle M being present refers to, for example, there being no surrounding vehicles present within a specific distance in front or behind of the vehicle M in the travel lane, and no surroundings vehicles present within a specific distance in front or behind in the lane change target lane adjacent to the travel lane.

The course candidate generation section 154 infers the position and state of the end point of the course for changing lanes based on the current position and state of the vehicle M. The course candidate generation section 154 generates a course from the start point to the end point by inputting the position and state of the start point of the vehicle M and the inferred position and state of the end point into a function that determines a course from a start point to an end point.

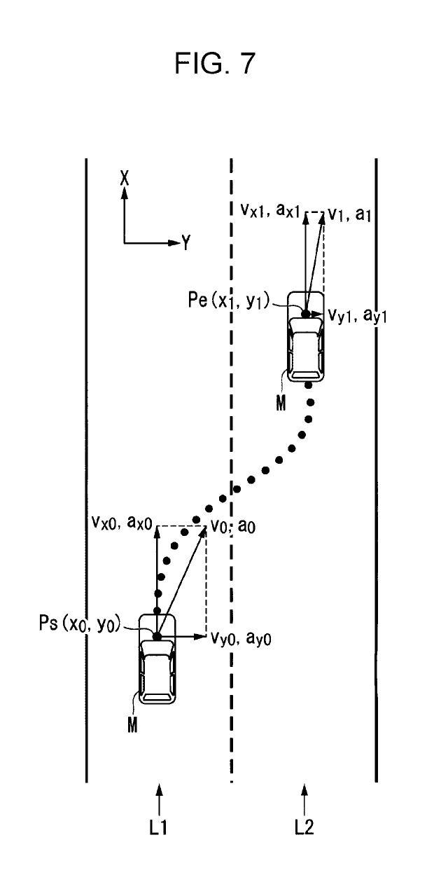

FIG. 7 is a diagram for explaining processing to calculate the course executed by the course candidate generation section 154 of the present embodiment. The space in which the vehicle M is present is represented by XY coordinates in FIG. 7. The X axis, for example, matches with the extension direction of the road. The course candidate generation section 154 calculates a curve connecting a start point Ps to an end point Pe using the function, or a map or the like having similar properties to the function.

As illustrated in FIG. 7, the speed of the vehicle M at the coordinates (x₀, y₀) of the start point Ps is defined as v₀, and the acceleration is defined as a₀. The speed v₀ of the vehicle M is a speed vector that combines the x direction component of the speed, vₓ₀, and the y direction component of the speed, v_{y0}. The acceleration a₀ of the vehicle M is an acceleration vector that combines the x direction component of the acceleration, aₓ₀, and the y direction component of the acceleration, a_{y0}.

The speed of the vehicle M at the coordinates (x₁, y₁) of the end point Pe is defined as v₁, and the acceleration is defined as a₁. The speed v₁ of the vehicle M is a speed vector that combines the x direction component of the speed, vₓ₁, and the y direction component of the speed, v_{y1}. Acceleration a₁ of the vehicle M is an acceleration vector that combines the x direction component of the acceleration, aₓ₁, and the y direction component of the acceleration, a_{y1}.

The time needed for the vehicle M to arrive at the end point Pe from the start point Ps is defined as the needed time T. The course candidate generation section 154 derives each point (x, y) from the start point Ps to the end point Pe using the spline functions of Equation (1) and Equation (2).

x:ƒ(t)=m₅t⁵+m₄t⁴+m₃t³+½aₓ₀t²+k₁vₓ₀t+x₀ (1))

y:ƒ(t)=m₅t⁵+m₄t⁴+m₃t³+½a_{y0}t²+k₂v_{y0}t+y₀ (2)

In Equation (1) and Equation (2), m₅, m₄, and m₃ are expressed by Equation (3), Equation (4), and Equation (5). In Equation (1) and Equation (2), the coefficients k₁ and k₂ may be the same as each other or different from each other.

$$\begin{matrix}{m}_{5} = - \frac{12 {p}_{0} - 12 {p}_{1} + 6 {v}_{0} T + 6 {v}_{1} T + {a}_{0} {T}^{2} - {a}_{1} {T}^{2}}{2 {T}^{5}} & ( 3 ) \\ {m}_{4} = \frac{30 {p}_{0} - 30 {p}_{1} + 16 {v}_{0} T + 14 {v}_{1} T + 3 {a}_{0} {T}^{2} - 2 {a}_{1} {T}^{2}}{2 {T}^{4}} & ( 4 ) \\ {m}_{3} = - \frac{20 {p}_{0} - 20 {p}_{1} + 12 {v}_{0} T + 8 {v}_{1} T + 3 {a}_{0} {T}^{2} - {a}_{1} {T}^{2}}{2 {T}^{3}} & ( 5 )\end{matrix}$$

In Equation (3), Equation (4), and Equation (5), p₀ is the position of the vehicle M at the start point Ps (x₀ when applied in Equation (1), y₀ when applied in Equation (2)), and p₁ is the position of the vehicle M at the end point Pe (x₁ when applied in Equation (1), y₁ when applied in Equation (2)).

The course candidate generation section 154 inputs the x direction component of the acceleration vector of the vehicle M of the start point Ps as aₓ₀, inputs the x direction component of the speed vector of the vehicle speed acquired by the vehicle sensor 60 at start point Ps as vₓ₀, and inputs the value of the X coordinate of the start point Ps as x₀, into Equation (1).

The course candidate generation section 154 inputs the y direction component of the acceleration vector of the vehicle M of the start point Ps as a_{y0}, inputs the y direction component of the speed vector of the vehicle speed acquired by the vehicle sensor 60 at start point Ps as v_{y0}, and inputs the value of the Y coordinate of the start point Ps as y₀, into Equation (2).

Moreover, the course candidate generation section 154 inputs the position of the vehicle M at the start point Ps as p₀, the position of the vehicle M at the end point Pe as p₁, a speed vector in the vehicle speed acquired by the vehicle sensor 60 at the start point Ps is input as v₀, the speed vector of the end point Pe is input as v₁, the acceleration vector of the vehicle M at the start point Ps is input as a₀, and the acceleration vector at the end point Pe is input as a₁, into Equations (3) to (5). Some information related to the speed or the acceleration at the end point Pe described above is determined based on a specific speed model.

The specific speed model predicts based on, for example, a fixed speed model that assumes that the vehicle M will travel while maintaining the current speed, a specific acceleration model that assumes that the vehicle M will travel while maintaining the current acceleration, a fixed jerk model that assumes that the vehicle will travel while maintaining the current jerk, and various other models. For example, the speeds input as v₀ and v₁ when the travelling under the fixed speed model are fixed, and the accelerations input as a₀ and a₁ are zero. When travelling under the fixed acceleration model, the accelerations input as a₀ and a₁ are fixed. When travelling under the fixed jerk model, the jerk, input as a₁, is a₀+J×needed time T (where J=da/dt (constant)).

The course candidate generation section 154 of the present embodiment also infers the end point Pe based on the needed time T that was inferred based on the amount of movement in the lateral direction by the vehicle M. The position of the end point Pe of the course for generating the desired course can thus be input to Equation (1) and Equation (2) while suppressing an increase in the processing load.

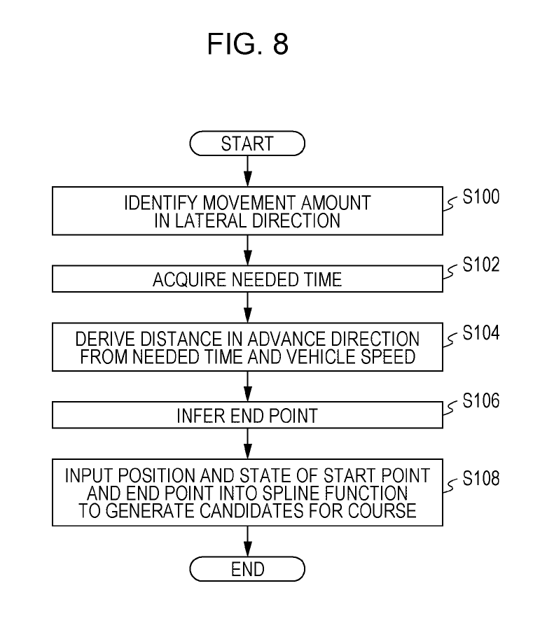

FIG. 8 is a flowchart illustrating a flow of processing to generate candidates for the course executed by the course candidate generation section 154. First, the course candidate generation section 154 identifies the movement amount in the lateral direction based on the information regarding the lane to be changed to acquired from the action plan generation section 140 (higher level) (step S100). The amount of movement in the lateral direction refers to the distance in the lateral direction (Y direction) from the vehicle M to a reference line. The reference line is, for example, the center of the lane change target lane.

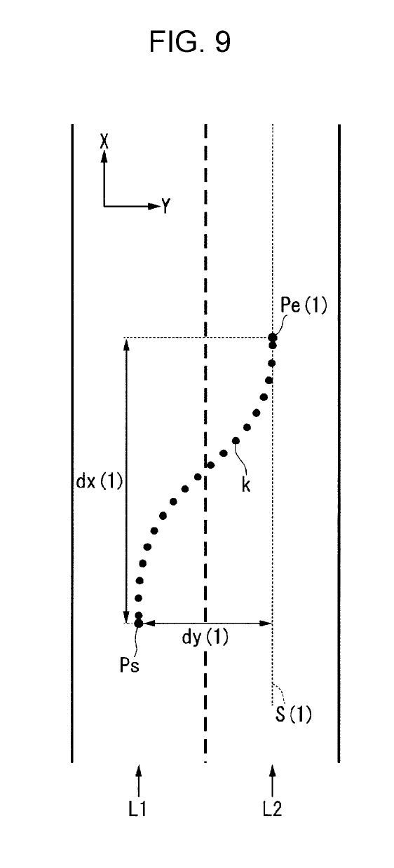

Next, the course candidate generation section 154 acquires the needed time T based on the identified amount of movement in the lateral direction (step S102). FIG. 9 is a diagram for explaining acquiring the needed time T. In FIG. 9, S(1) is the center line of an adjacent lane L2 to the lane change target of the vehicle M. For example, the needed time T is the movement time for moving to a center line S of the adjacent lane L2 in the lateral direction (the y direction) when the vehicle M changes lanes to the adjacent lane L2. In FIG. 9, the distance dy is the distance from the vehicle M to the center line S.

Note that the needed time T may be the value of the distance dy divided by the lateral direction movement speed Vy for movement of the vehicle M in the lateral direction, or a fixed value. When the needed time T is derived more precisely, the lateral direction movement speed Vy may be defined as a function of time, and the needed time T derived.

Next, the course candidate generation section 154 assumes that the vehicle M is travelling under the specific speed model, and derives the distance dx(1) of the end point Pe in the advance direction of the vehicle M based on the acquired needed time T and the vehicle speed (state) at the start point Ps (step S104). Moreover, dx(1) of FIG. 9 is the distance from the start point Ps to the end point Pe(1) in the advance direction of the vehicle M.

Next, the course candidate generation section 154 infers the position of the distance dx(1) from the current position of the vehicle M as the end point Pe(1) at the center line S(1) of the lane change target lane (step S106). Next, the course candidate generation section 154 inputs the position and state of the vehicle M at the start point Ps and the end point Pe(1) into the spline function to generate candidates for the course (step S108).

Then, the course candidate generation section 154 sets plural end points Pe in the surroundings of the generated candidates for the course, generates candidates for the course in accordance with the set end points Pe, and selects a course evaluated highly from out of the plural candidates for the course. The processing of the current flowchart thereby completes.

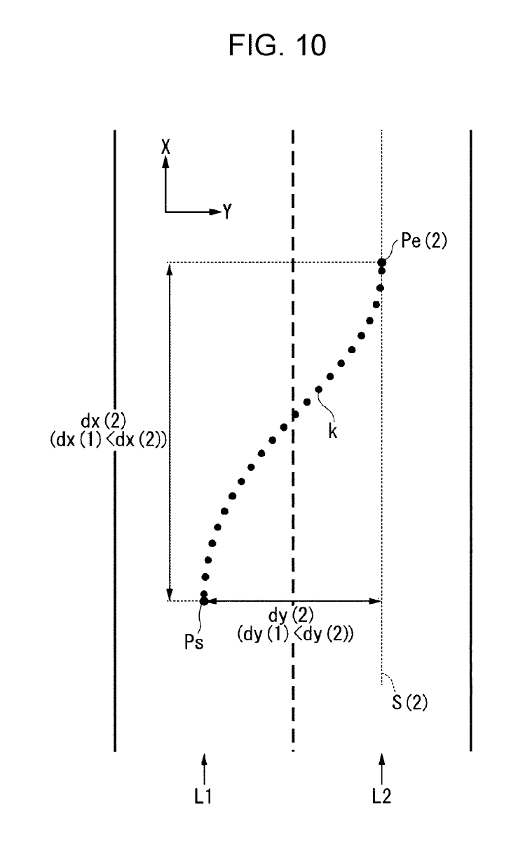

FIG. 10 is a diagram illustrating the end point Pe when the vehicle lane width is wider than in the example of FIG. 9. In this case, the distance dy(2) in the lateral direction (Y direction) from the start point Ps to the center line S(2) of the lane change target lane is a longer distance than the distance dy(l) of FIG. 9. When the speed in the lateral direction is a stipulated value, the distance dx(2) to the end point Pe is longer than the distance dx(1) of FIG. 9 if the initial speed in the advance direction and the speed model are the same. As a result, the course candidate generation section 154 sets the end point Pe(2) to the position of the distance dx(2) at the center line S(2) of the adjacent lane L2.

As described above, the course candidate generation section 154 of the present embodiment can generate appropriate courses using simple processing, by determining the position of the end point Pe based on the needed time T of the vehicle M and the current speed v₀ of the vehicle M.

Note that although explanation has been given in which the course candidate generation section 154 employs a spline function in the present embodiment, another specific function may be employed instead. The specific function is a function that generates a curve by interpolation from the start point to the end point when at least the position and state of the start point and the position and state of the end point have been set.

Although explanation has been given in which the course candidate generation section 154 employs a function in the present embodiment, a map that derives a desired course in accordance with set values when the position and state of the start point, the position and state of the end point, and the needed time T are set may be employed instead.

Although explanation has been given in which the course candidate generation section 154 executes the processing described above when changing lanes in the present embodiment, there is no limitation thereto, the position of the end point Pe may be determined based on the needed time T of the vehicle M and the current speed V₀ of the vehicle M in cases in which the vehicle M moves in the lateral direction.

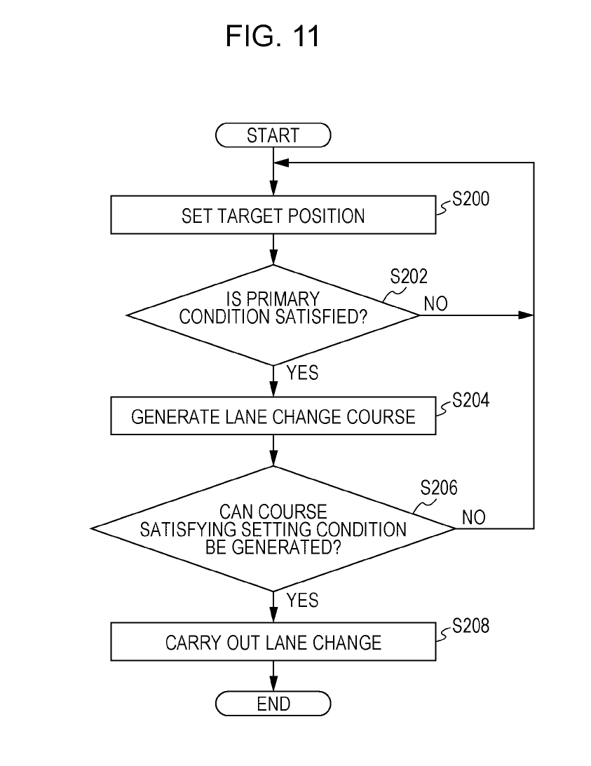

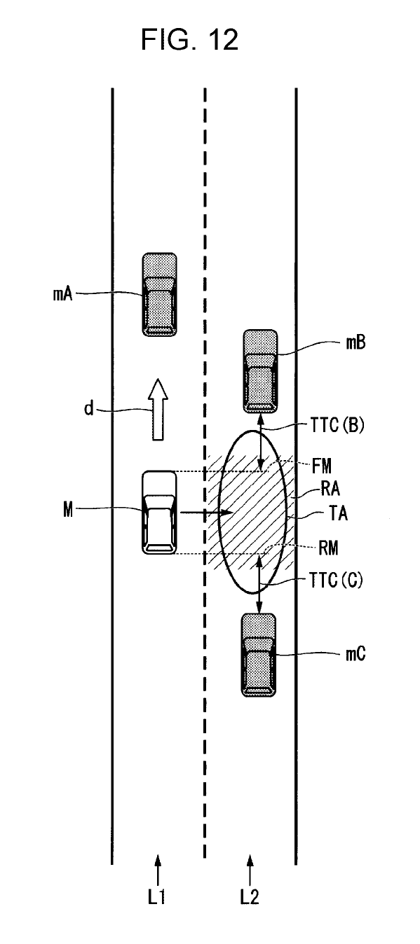

FIG. 11 is a flowchart illustrating another example of a flow of processing executed when implementing a lane-change event. Explanation follows regarding processing, with reference to FIG. 11 and FIG. 12. The current processing is an example of processing executed when surrounding vehicles are present at the lane change target of the vehicle M.

First, the lane change controller 158 selects two surrounding vehicles out of surrounding vehicles travelling in an adjacent lane change target lane, which is an adjacent lane adjacent to the lane that the vehicle M is travelling in (the vehicle lane), and sets a target position TA between these surrounding vehicles (step S200). In the explanation that follows, a forward reference vehicle mB is defined as a surrounding vehicle travelling directly in front of the target position TA in the adjacent lane, and a rear reference vehicle mC is defined as a surrounding vehicle travelling directly behind the target position TA in the adjacent lane. The target position TA is a relative position based on a positional relationship between the vehicle M and the forward reference vehicle mB and the rear reference vehicle mC.

FIG. 12 is a diagram illustrating a state in which the target position TA is set. In FIG. 12, mA denotes the vehicle in front, mB denotes the forward reference vehicle, and mC denotes the rear reference vehicle. The arrow d denotes the advance (travelling) direction of the vehicle M, L1 denotes the vehicle lane, and L2 denotes the adjacent lane. In the case of the example of FIG. 12, the lane change controller 158 sets the target position TA between the forward reference vehicle mB and the rear reference vehicle mC in the adjacent lane L2.

Next, the lane change controller 158 determines whether or not a primary condition for determining whether or not the lane change to the target position TA (namely, between the forward reference vehicle mB and the rear reference vehicle mC) is possible is satisfied (step S202).

The primary condition is, for example, that not even a portion of a surrounding vehicle is present in a forbidden region RA provided in the adjacent lane, and that TTCs between the vehicle M and the forward reference vehicle mB and between the vehicle M and the rear reference vehicle mC are both greater than the threshold value. Note that the determination condition is an example for a case in which the target position TA has been set at a side of the vehicle M. When the primary condition is not satisfied, the lane change controller 158 returns processing to step S200, and sets the target position TA anew. When doing so, standby may be performed until a timing when the target position TA can be set so as to satisfy the primary condition, or the target position TA may be changed and a speed control for moving to the side of the target position TA may be performed.

As illustrated in FIG. 12, the lane change controller 158, for example, projects the vehicle M onto the adjacent lane L2 of the lane change target, and sets the forbidden region RA so as to maintain a small leeway distance in front and behind. The forbidden region RA is set as a region that extends from one end of the adjacent lane L2 to another end in the lateral direction.

In cases in which surrounding vehicles are not present in the forbidden region RA, the lane change controller 158, for example, estimates a hypothetical extension line FM and a hypothetical extension line RM for the front end and rear end of the vehicle M extending toward the adjacent lane L2 side of the lane change target. The lane change controller 158 computes a time to collision TTC(B) for the extension line FM and the forward reference vehicle mB, and computes a time to collision TTC(C) for the extension line RM and the rear reference vehicle mC. The time to collision TTC(B) is a time derived by dividing the distance between the forward reference vehicle mB and the extension line FM by the relative speed between the vehicle M and the forward reference vehicle mB. The time to collision TTC(C) is a time derived by dividing the distance between the extension line RM and the rear reference vehicle mC by the relative speed between the vehicle M and the rear reference vehicle mC. The lane change controller 158 determines that the primary condition is satisfied when the time to collision TTC(B) is greater than a threshold value Th(B) and the time to collision TTC(C) is greater than a threshold value Th(C). The threshold values Th(B) and Th(C) may be the same value, or may be different values from each other.

When the primary condition is satisfied, the lane change controller 158 causes the course candidate generation section 154 to generate candidates for the course for lane changing (step S204). FIG. 13 is a diagram illustrating a state in which courses for lane changing are generated. For example, the course candidate generation section 154 assumes that the vehicle in front mA, the forward reference vehicle mB, and the rear reference vehicle mC are travelling under the specific speed model, and generates candidates for the course based on the speed model of the three vehicles and the speed of the vehicle M, such that the vehicle M does not interfere with the vehicle in front mA, and so as to position the vehicle M between the forward reference vehicle mB and the rear reference vehicle mC at a given timing in the future. For example, the course candidate generation section 154 creates a smooth link from the current position of the vehicle M, to a position of the forward reference vehicle mB at a given timing in the future, or to the center of the lane change target lane and an end point of the lane change, using a polynomial function such as a spline function, and disposes a specific number of course points K at even separations or uneven separations on this curve. When doing so, the course candidate generation section 154 generates the course such that at least one of the course points K is disposed within the target position TA.

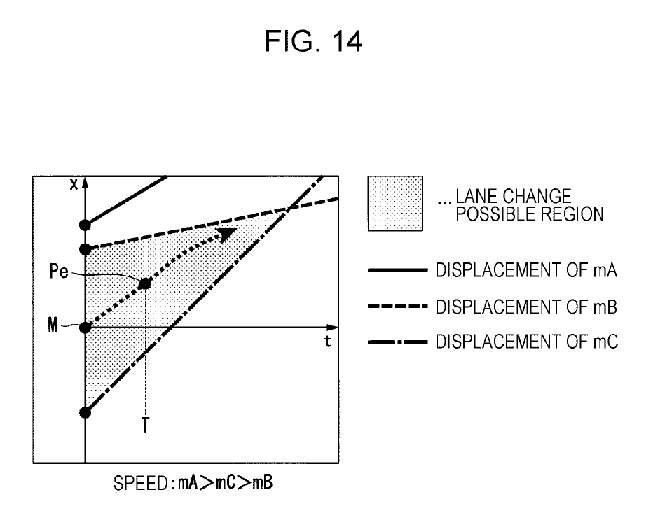

More specifically, for example, the course candidate generation section 154 infers the end point Pe using the processing described above. The course candidate generation section 154 predicts the future displacement of the surrounding vehicles, and generates a course to the inferred end point Pe applying the predicted displacement. FIG. 14 illustrates an example applying the predicted future displacement of the surrounding vehicles to the end point Pe. The illustrated example is an example in which the future displacement of the surrounding vehicles is predicted using a fixed speed model that assumes that the surrounding vehicles will travel while maintaining their current speeds.

In FIG. 14, similarly to in FIG. 12 and FIG. 13, the positional relationship between the surrounding vehicles is that the vehicle in front mA is travelling furthest ahead, the forward reference vehicle mB is next furthest ahead, the vehicle M is next furthest ahead, and the rear reference vehicle mC is travelling furthest behind. The vertical axis of FIG. 14 represents displacement x in the advance direction from the current position of the vehicle M, which serves as a source point, and the horizontal axis represents elapsed time t. A lane-change-possible region is below the displacement of the vehicle in front mA until the lane change, is lower than the displacement of the forward reference vehicle mB, and is higher than the rear reference vehicle mC.

For example, the course candidate generation section 154 selects a specific speed model such that the end point Pe is contained within the lane-change-possible region at the needed time T. In the example of FIG. 14, a lane change at a constant speed may be determined since it is possible to enter the lane-change-possible region when having traveled at constant speed. For example, the course candidate generation section 154 generates a course following the forward reference vehicle mB in accordance with that position after the needed time T.

Next, the evaluation/selection section 156 determines whether or not candidates for the course satisfying a setting condition can be generated (step S206). The setting condition is, for example, that an evaluation value of a threshold value or greater is obtained from the viewpoint of plan quality and safety as described above. When a candidate for the course satisfying the setting condition can be generated, the evaluation/selection section 156 selects, for example, the candidate for the course having the highest evaluation value, outputs information regarding the course to the travelling controller 160, and carries out the lane change (step S208). However, in cases in which a course satisfying the setting condition could not be generated, processing returns to step S200. When this occurs, similarly to in cases in which a negative determination was made at step S202, a standby state may be adopted, and processing may be performed to set the target position TA anew.

The travelling controller 160 controls the travelling drive force output device 90, the steering device 92, and the brake device 94 such that the vehicle M passes through the course generated by the course generation section 150 as prescribed by planned timings.

In addition to changing the driving mode based on the driving mode designation signal input from the switching switch 80, the switch controller 170 also changes the driving mode based on the operations on the operation devices 70 that instruct acceleration, deceleration, or steering. For example, when a state in which the operation amount input from the operation detection sensors 72 has exceeded a threshold value has continued for a reference time or longer, the switch controller 170 switches from the self-driving mode to the manual driving mode. The switch controller 170 also switches the driving mode from the self-driving mode to the manual driving mode in the vicinity of the destination of self-driving.

When switching from the manual driving mode to the self-driving mode, the switch controller 170 performs this based on the driving mode designation signal input from the switching switch 80. Control may also be performed that returns to the self-driving mode in cases in which operations on the operation devices 70 instructing acceleration, deceleration, or steering have not been detected during a specific time after having switched from self-driving mode to manual driving mode.

According to the first embodiment explained above, the vehicle control system 100 can generate a suitable course by simple processing, by inferring the position and state of the end point based on the current position and state of the vehicle M and inputting the position and state of the start point of the vehicle M, and the position and state of the inferred end point, into a function that determines a course from the start point to the end point.

### Second Embodiment

Explanation follows regarding a second embodiment. A vehicle control system 100A of the second embodiment differs from the first embodiment in that the vehicle control system 100A sets events based on a route to the destination, and automatically controls the vehicle M such that the vehicle M changes lanes when the vehicle M is simply changing lanes without performing self-driving. Explanation follows centered on such differences. Configuration elements having similar functionality to the first embodiment are allocated the same reference numerals, and explanation thereof is omitted as appropriate.

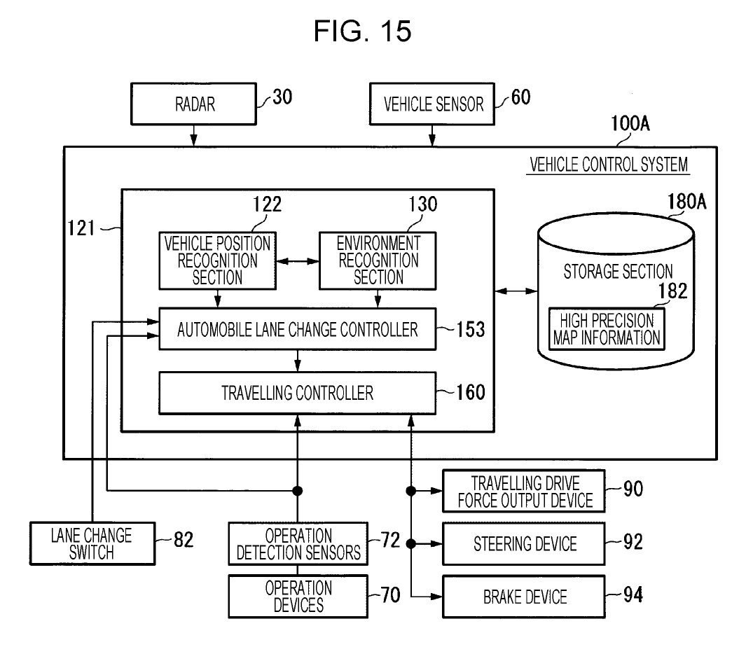

FIG. 15 is a functional configuration diagram of the vehicle M centered on the vehicle control system 100A according to the second embodiment. The radars 30, the vehicle sensor 60, the operation devices 70, the operation detection sensors 72, a lane change switch 82, the travelling drive force output device 90, the steering device 92, the brake device 94, and the vehicle control system 100A are installed to the vehicle M. The vehicle control system 100A includes a driving support section 121 and a storage section 180A. The driving support section 121 includes, for example, the vehicle position recognition section 122, the environment recognition section 130, an automatic lane change controller 153, and the travelling controller 160. The storage section 180A stores the high precision map information 182.

The lane change switch 82 is a switch operated by the driver or the like. The lane change switch 82 receives the operation by the driver or the like, generates a control mode designation signal that designates the mode of control by the travelling controller 160 as either an automatic lane change mode or a manual driving mode, and outputs the designated mode to the automatic lane change controller 153. The automatic lane change mode is a mode in which the vehicle M changes lanes automatically due to control by the automatic lane change controller 153.

For example, the lane change switch 82 includes, for example, a lane change switch R that accepts lane changes to an adjacent lane on the right side, and a lane change switch L that accepts lane changes to an adjacent lane on the left side. When the lane change switch R is operated by the driver or the like, the lane change switch R generates a mode designation signal designating the automatic lane change mode for changing lanes to the right, and outputs the generated mode designation signal to the automatic lane change controller 153. When the lane change switch L is operated by the driver or the like, the lane change switch L generates a mode designation signal designating the automatic lane change mode for changing lanes to the left, and outputs the generated mode designation signal to the automatic lane change controller 153. The lane change switch 82 may be a turn signal.

The automatic lane change controller 153 has functionality equivalent to that the of the course candidate generation section 154, the evaluation/selection section 156, and the lane change controller 158 of the first embodiment. When an operation by the driver or the like has been received by the lane change switch 82, the automatic lane change controller 153 generates a course for performing the lane change based on information acquired by the vehicle position recognition section 122 and information acquired by the environment recognition section 130. When no surrounding vehicles are present in the surroundings of the vehicle M, the automatic lane change controller 153 generates a course from the start point to the end point by inputting the position and state of the start point of the vehicle M and the position and state of the inferred end point into a function that determines a course from the start point to the end point.

When surrounding vehicles are present in the surroundings of the vehicle M, the automatic lane change controller 153 predicts a future displacement of the positions of the surrounding vehicles using the specific speed model. The automatic lane change controller 153 selects the specific speed model such that the end point Pe is contained within the lane-change-possible region within the needed time T, and generates a course for lane changing. The travelling controller 160 acquires the course generated by the automatic lane change controller 153, and controls the operation amount of the travelling drive force output device 90, the steering device 92, the brake device 94, and the accelerator pedal such that the vehicle M travels along the acquired course.

According to the second embodiment explained above, the vehicle control system 100A infers the position and state of the end point based on the current position and state of the vehicle M, and can generate a suitable course by simple processing, by inputting the position and state of the start point of the vehicle M and the position and state of the inferred end point into a function that determines a course from the start point to the end point.

Although explanation has been given regarding modes for implementing the present disclosure with reference to embodiments, the present disclosure is not limited to these embodiments in any way, and various modifications and substitutions can be made within a range that does not depart from the spirit of the present disclosure.

What is claimed is:

1. A vehicle control system comprising:
a course generator programmed to utilize a function that generates a course from a start point to an end point by inputting into the function a position and state of the start point and a position and state of the end point, the course generator being configured to infer a position and state of an end point of a vehicle based on a current position and state of the vehicle and configured to generate an expected course of the vehicle by inputting the current position and state of the vehicle and the inferred position and state of the end point of the vehicle into the function; and
a travelling controller configured to automatically control at least steering of the vehicle such that the vehicle travels on the expected course generated by the course generator.

2. The vehicle control system according to claim 1, wherein
the function further requires input of a needed time taken for the vehicle to move from the start point to the end point; and
the course generator further infers the needed time based on an amount of movement in a lateral direction by the vehicle generate the expected course by inputting the inferred needed time into the function.

3. The vehicle control system according to claim 2, wherein
the course generator infers the position of the end point as a position further from the vehicle, the longer the length of the needed time.

4. The vehicle control system according to claim 1, wherein
the function is a spline function.

5. A vehicle control method performed by an onboard computer, the method comprising:
providing a function that generates a course from a start point to an end point by inputting into the function a position and state of the start point and a position and state of the end point;
inferring a position and state of an end point of a vehicle based on a current position and state of the vehicle;
generating an expected course of the vehicle by inputting the current position and state of the vehicle and the inferred position and state of the end point of the vehicle into the function; and
automatically controlling at least steering of the vehicle such that the vehicle travels on the generated expected course.

6. A vehicle control program that causes an onboard computer to execute the steps of:
providing a function that generates a course from a start point to an end point by inputting into the function a position and state of the start point and a position and state of the end point;
inferring a position and state of an end point of a vehicle based on a current position and state of the vehicle;
generating an expected course of the vehicle by inputting the current position and state of the vehicle and the inferred position and state of the end point of the vehicle into the function; and
automatically controlling at least steering of the vehicle such that the vehicle travels on the generated expected course.
